(19) United States
(12) Patent Application Publication
(10) Pub. No.: US 2024/0049242 A1
(43) Pub. Date: Feb. 8, 2024

(54) CROSS-TRANSMISSION AND RECEPTION POINT (TRP) INDICATION OF A TRANSMISSION CONFIGURATION INDICATION STATE

(71) Applicant: QUALCOMM Incorporation, San Diego, CA (US)

(72) Inventors: Tianyang Bai, Somerville, NJ (US); Yan Zhou, San Diego, CA (US); Junyi Li, Fairless Hills, PA (US); Tao Luo, San Diego, CA (US)

(21) Appl. No.: 17/877,750

(22) Filed: Jul. 29, 2022

(51) Int. Cl. H04W 72/04

(52) U.S. Cl. CPC H04W 72/042

(57) ABSTRACT

Methods, systems, and devices for wireless communications are described. The described techniques provide for efficiently indicating transmission configuration indication (TCI) states to a user equipment (UE) for communicating with one or more transmission and reception points (TRPs). A first TRP may transmit an indication to a UE of a first TCI state for communicating with a second TRP. The first TCI state may be selected from a set of TCI states activated at the UE for communicating with the second TRP. The indication, from the first TRP, of the first TCI state, for communicating with the second TRP, may be referred to as a cross-TRP TCI indication. The UE may receive the indication of the first TCI state from the first TRP and may communicate with the second TRP according to the first TCI state.

### FIELD OF TECHNOLOGY

The following relates to wireless communications, including a cross-transmission and reception point (TRP) indication of a transmission configuration indication state.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support beamformed or beam-based communication between a UE and a transmission and reception point (TRP). Improved techniques for beamformed or beam-based communications may be desirable.

### SUMMARY

The described techniques relate to improved methods, systems, devices, and apparatuses that support a cross-transmission and reception point (TRP) indication of a transmission configuration indication (TCI) state. A first TRP may transmit an indication to a UE of a first TCI state for communicating with a second TRP. The first TCI state may be selected from a set of TCI states activated at the UE for communicating with the second TRP. The indication, from the first TRP, of the first TCI state, for communicating with the second TRP, may be referred to as a cross-TRP TCI indication. The UE may receive the indication of the first TCI state from the first TRP and may communicate with the second TRP according to the first TCI state. For instance, the UE may determine a beam for communicating with the second TRP based on the first TCI state.

A method for wireless communication is described. The method may include receiving an indication of a first set of transmission configuration indication states activated for a first transmission and reception point and a second set of transmission configuration indication states activated for a second transmission and reception point, receiving, in downlink control information from the first transmission and reception point, an indication of a first transmission configuration indication state for communicating with the second transmission and reception point, the first transmission configuration indication state being from the second set of transmission configuration states, and communicating with the second transmission and reception point in accordance with the first transmission configuration indication state.

An apparatus for wireless communication is described. The apparatus may include a processor, memory coupled with the processor, and instructions stored in the memory. The instructions may be executable by the processor to cause the apparatus to receive an indication of a first set of transmission configuration indication states activated for a first transmission and reception point and a second set of transmission configuration indication states activated for a second transmission and reception point, receive, in downlink control information from the first transmission and reception point, an indication of a first transmission configuration indication state for communicating with the second transmission and reception point, the first transmission configuration indication state being from the second set of transmission configuration states, and communicate with the second transmission and reception point in accordance with the first transmission configuration indication state.

Another apparatus for wireless communication is described. The apparatus may include means for receiving an indication of a first set of transmission configuration indication states activated for a first transmission and reception point and a second set of transmission configuration indication states activated for a second transmission and reception point, means for receiving, in downlink control information from the first transmission and reception point, an indication of a first transmission configuration indication state for communicating with the second transmission and reception point, the first transmission configuration indication state being from the second set of transmission configuration states, and means for communicating with the second transmission and reception point in accordance with the first transmission configuration indication state.

A non-transitory computer-readable medium storing code for wireless communication is described. The code may include instructions executable by a processor to receive an indication of a first set of transmission configuration indication states activated for a first transmission and reception point and a second set of transmission configuration indication states activated for a second transmission and reception point, receive, in downlink control information from the first transmission and reception point, an indication of a first transmission configuration indication state for communicating with the second transmission and reception point, the first transmission configuration indication state being from the second set of transmission configuration states, and communicate with the second transmission and reception point in accordance with the first transmission configuration indication state.

In some examples of the method, apparatuses, and non-transitory computer-readable medium described herein, the downlink control information further includes an indication of a second transmission configuration indication state for communicating with the first transmission and reception point and the method, apparatuses, and non-transitory computer-readable medium may include further operations, features, means, or instructions for communicating with the first transmission and reception point in accordance with the second transmission configuration indication state.

Some examples of the method, apparatuses, and non-transitory computer-readable medium described herein may further include operations, features, means, or instructions for receiving, in the downlink control information, a first indicator to apply the first transmission configuration indication state for communicating with the second transmission and reception point.

In some examples of the method, apparatuses, and non-transitory computer-readable medium described herein, the first indicator may be different from a second indicator to apply a second transmission configuration indication state for communicating with the first transmission and reception point, the second transmission configuration indication state being from the first set of transmission configuration indication states and the first indicator may be different from a third indicator to apply the first transmission configuration indication state for communicating with the second transmission and reception point and the second transmission configuration indication state for communicating with the first transmission and reception point.

In some examples of the method, apparatuses, and non-transitory computer-readable medium described herein, the first indicator includes one or more bits or a validation sequence.

Some examples of the method, apparatuses, and non-transitory computer-readable medium described herein may further include operations, features, means, or instructions for receiving, in the downlink control information, a first field including the first transmission configuration indication state, the first field being dedicated to the second transmission and reception point and being different from a second field in the downlink control information dedicated to the first transmission and reception point.

Some examples of the method, apparatuses, and non-transitory computer-readable medium described herein may further include operations, features, means, or instructions for receiving, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

Some examples of the method, apparatuses, and non-transitory computer-readable medium described herein may further include operations, features, means, or instructions for receiving, in the downlink control information, an indication of a second transmission configuration indication state for communicating with the first transmission and reception point, the second transmission configuration indication state being from the first set of transmission configuration indication states and determining the first transmission configuration indication state for communicating with the second transmission and reception point based on the second transmission configuration indication state for communicating with the first transmission and reception point.

Some examples of the method, apparatuses, and non-transitory computer-readable medium described herein may further include operations, features, means, or instructions for receiving an indication that the second transmission configuration indication state may be linked to the first transmission configuration indication state.

In some examples of the method, apparatuses, and non-transitory computer-readable medium described herein, the second transmission configuration indication state may be linked to the first transmission configuration indication state according to a predefined rule.

Some examples of the method, apparatuses, and non-transitory computer-readable medium described herein may further include operations, features, means, or instructions for receiving, in the downlink control information, a first indicator to apply the first transmission configuration indication state for communicating with the second transmission and reception point.

Some examples of the method, apparatuses, and non-transitory computer-readable medium described herein may further include operations, features, means, or instructions for receiving, in the downlink control information, a third indicator to apply the first transmission configuration indication state for communicating with the second transmission and reception point and the second transmission configuration indication state for communicating with the first transmission and reception point.

In some examples of the method, apparatuses, and non-transitory computer-readable medium described herein, a common application time or separate application times may be configured for communicating with the second transmission and reception point in accordance with the first transmission configuration indication state and communicating with the first transmission and reception point in accordance with a second transmission configuration indication state.

In some examples of the method, apparatuses, and non-transitory computer-readable medium described herein, the downlink control information includes the indication of the first transmission configuration indication state without scheduling communications.

A method for wireless communication is described. The method may include transmitting an indication of a first set of transmission configuration indication states activated for a first transmission and reception point and a second set of transmission configuration indication states activated for a second transmission and reception point and transmitting, in downlink control information from the first transmission and reception point, an indication of a first transmission configuration indication state for communicating with the second transmission and reception point, the first transmission configuration indication state being from the second set of transmission configuration states.

An apparatus for wireless communication is described. The apparatus may include a processor, memory coupled with the processor, and instructions stored in the memory. The instructions may be executable by the processor to cause the apparatus to transmit an indication of a first set of transmission configuration indication states activated for a first transmission and reception point and a second set of transmission configuration indication states activated for a second transmission and reception point and transmit, in downlink control information from the first transmission and reception point, an indication of a first transmission configuration indication state for communicating with the second transmission and reception point, the first transmission configuration indication state being from the second set of transmission configuration states.

Another apparatus for wireless communication is described. The apparatus may include means for transmitting an indication of a first set of transmission configuration indication states activated for a first transmission and reception point and a second set of transmission configuration indication states activated for a second transmission and reception point and means for transmitting, in downlink control information from the first transmission and reception point, an indication of a first transmission configuration indication state for communicating with the second transmission and reception point, the first transmission configuration indication state being from the second set of transmission configuration states.

A non-transitory computer-readable medium storing code for wireless communication is described. The code may include instructions executable by a processor to transmit an indication of a first set of transmission configuration indication states activated for a first transmission and reception point and a second set of transmission configuration indication states activated for a second transmission and reception point and transmit, in downlink control information from the first transmission and reception point, an indication of a first transmission configuration indication state for communicating with the second transmission and reception point, the first transmission configuration indication state being from the second set of transmission configuration states.

In some examples of the method, apparatuses, and non-transitory computer-readable medium described herein, the downlink control information further includes an indication of a second transmission configuration indication state for communicating with the first transmission and reception point, the second transmission configuration indication state being from the first set of transmission configuration indication states.

Some examples of the method, apparatuses, and non-transitory computer-readable medium described herein may further include operations, features, means, or instructions for transmitting, in the downlink control information, a first indicator to apply the first transmission configuration indication state for communicating with the second transmission and reception point.

In some examples of the method, apparatuses, and non-transitory computer-readable medium described herein, the first indicator may be different from a second indicator to apply a second transmission configuration indication state for communicating with the first transmission and reception point, the second transmission configuration indication state being from the first set of transmission configuration indication states and the first indicator may be different from a third indicator to apply the first transmission configuration indication state for communicating with the second transmission and reception point and the second transmission configuration indication state for communicating with the first transmission and reception point.

In some examples of the method, apparatuses, and non-transitory computer-readable medium described herein, the first indicator includes one or more bits or a validation sequence.

Some examples of the method, apparatuses, and non-transitory computer-readable medium described herein may further include operations, features, means, or instructions for transmitting, in the downlink control information, a first field including the first transmission configuration indication state, the first field being dedicated to the second transmission and reception point and being different from a second field in the downlink control information dedicated to the first transmission and reception point.

Some examples of the method, apparatuses, and non-transitory computer-readable medium described herein may further include operations, features, means, or instructions for transmitting, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

Some examples of the method, apparatuses, and non-transitory computer-readable medium described herein may further include operations, features, means, or instructions for transmitting, in the downlink control information, an indication of a second transmission configuration indication state for communicating with the first transmission and reception point, the second transmission configuration indication state being from the first set of transmission configuration indication states, and the second transmission configuration indication state being linked to the first transmission configuration indication state.

Some examples of the method, apparatuses, and non-transitory computer-readable medium described herein may further include operations, features, means, or instructions for transmitting an indication that the second transmission configuration indication state may be linked to the first transmission configuration indication state.

In some examples of the method, apparatuses, and non-transitory computer-readable medium described herein, the second transmission configuration indication state may be linked to the first transmission configuration indication state according to a predefined rule.

Some examples of the method, apparatuses, and non-transitory computer-readable medium described herein may further include operations, features, means, or instructions for transmitting, in the downlink control information, a first indicator to apply the first transmission configuration indication state for communicating with the second transmission and reception point.

Some examples of the method, apparatuses, and non-transitory computer-readable medium described herein may further include operations, features, means, or instructions for transmitting, in the downlink control information, a third indicator to apply the first transmission configuration indication state for communicating with the second transmission and reception point and the second transmission configuration indication state for communicating with the first transmission and reception point.

In some examples of the method, apparatuses, and non-transitory computer-readable medium described herein, a common application time or separate application times may be configured for communicating with the second transmission and reception point in accordance with the first transmission configuration indication state and communicating with the first transmission and reception point in accordance with a second transmission configuration indication state.

In some examples of the method, apparatuses, and non-transitory computer-readable medium described herein, the downlink control information includes the indication of the first transmission configuration indication state without scheduling communications.

### BRIEF DESCRIPTION OF THE DRAWINGS

FIG. 1 illustrates an example of a wireless communications system that supports a cross-transmission and reception point (TRP) indication of a transmission configuration indication (TCI) state in accordance with one or more aspects of the present disclosure.

FIG. 2 illustrates an example of a wireless communications system that supports a cross-TRP indication of a TCI state in accordance with one or more aspects of the present disclosure.

FIG. 3 shows a block diagram of signaling supporting downlink control information (DCI) without an assignment in accordance with one or more aspects of the present disclosure.

FIG. 4 illustrates an example of a process flow that supports a cross-TRP indication of a TCI state in accordance with one or more aspects of the present disclosure.

FIGS. 5 and 6 show block diagrams of devices that support a cross-TRP indication of a TCI state in accordance with one or more aspects of the present disclosure.

FIG. 7 shows a block diagram of a communications manager that supports a cross-TRP indication of a TCI state in accordance with one or more aspects of the present disclosure.

FIG. 8 shows a diagram of a system including a device that supports a cross-TRP indication of a TCI state in accordance with one or more aspects of the present disclosure.

FIGS. 9 and 10 show block diagrams of devices that support a cross-TRP indication of a TCI state in accordance with one or more aspects of the present disclosure.

FIG. 11 shows a block diagram of a communications manager that supports a cross-TRP indication of a TCI state in accordance with one or more aspects of the present disclosure.

FIG. 12 shows a diagram of a system including a device that supports a cross-TRP indication of a TCI state in accordance with one or more aspects of the present disclosure.

FIGS. 13 and 14 show flowcharts illustrating methods that support a cross-TRP indication of a TCI state in accordance with one or more aspects of the present disclosure.

### DETAILED DESCRIPTION

Some wireless communications systems may support beamformed or beam-based communications between a user equipment (UE) and a transmission and reception point (TRP). The UE may have access to multiple beams or may be able to generate or receive via multiple beams, and it may be appropriate for the UE to identify a suitable beam for communicating with the TRP. In some examples, a transmission configuration indication (TCI) framework may be implemented to indicate suitable transmission configurations (e.g., beams or beam weights) for communications between a UE and a TRP. The TRP may transmit an indication of a TCI state to the UE, and the UE may determine a beam for communicating with the TRP based on the TCI state. For a UE configured to communicate with a single TRP, the single TRP may transmit an indication of a TCI state to the UE for communicating with the TRP. For a UE configured to communicate with multiple TRPs, however, it may be challenging to indicate a TCI state to the UE for communicating with each of the multiple TRPs (e.g., with minimal overhead and low latency).

The described techniques provide for efficiently indicating TCI states to a UE for communicating with one or more TRPs. A first TRP may transmit an indication to a UE of a first TCI state for communicating with a second TRP. The first TCI state may be selected from a set of TCI states activated at the UE for communicating with the second TRP. The indication, from the first TRP, of the first TCI state, for communicating with the second TRP, may be referred to as a cross-TRP TCI indication. The UE may receive the indication of the first TCI state from the first TRP and may communicate with the second TRP according to the first TCI state. For instance, the UE may determine a beam for communicating with the second TRP based on the first TCI state.

The use of cross-TRP TCI indications may allow for improved flexibility when indicating TCI states, which, in turn, may improve other aspects of communication in the wireless communications system. In one example, a first TRP may transmit an indication of a first TCI state for communicating with a second TRP in a same DCI used to schedule communications for communicating with the first TRP. That is, the first TRP may schedule communications with the first TRP and indicate the first TCI state for the second TRP in the same DCI. In this example, the second TRP may avoid transmitting another DCI to indicate the first TCI state to the UE, resulting in reduced overhead. In another example, a first TRP may transmit an indication of a first TCI state to a UE earlier than a second TRP would be able to transmit the indication of the first TCI state to the UE (e.g., based on a timing of resources allocated to the first TRP and the second TRP for transmitting control information).

Aspects of the disclosure are initially described in the context of wireless communications systems. Aspects of the disclosure are further illustrated by and described with reference to apparatus diagrams, system diagrams, and flowcharts that relate to a cross-TRP point indication of a transmission configuration indication state.

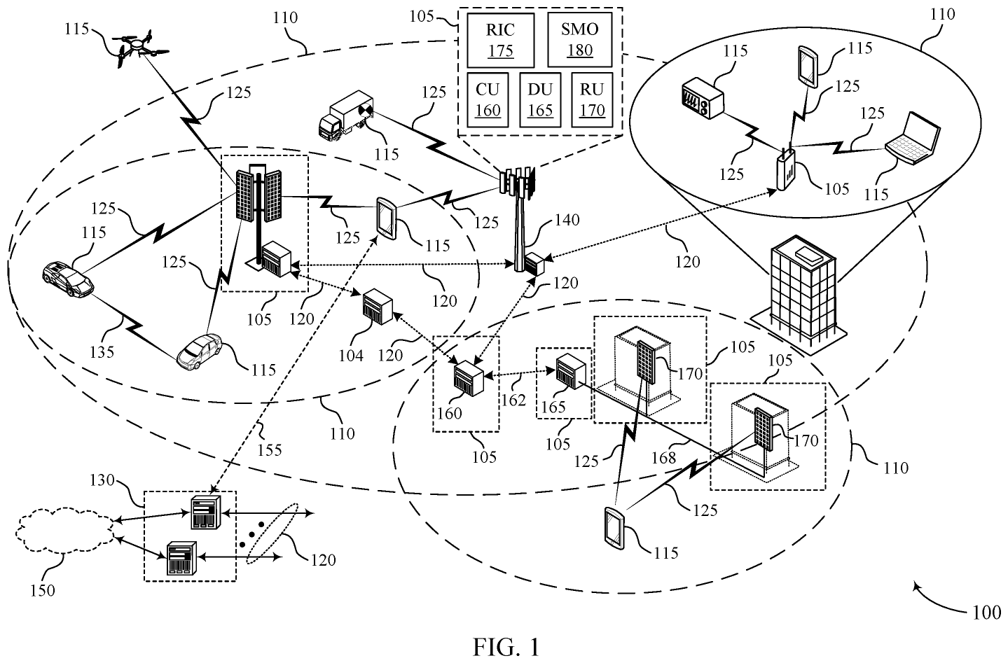

FIG. 1 illustrates an example of a wireless communications system 100 that supports a cross-TRP indication of a transmission configuration indication state in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support a cross-TRP indication of a transmission configuration indication state as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115 (e.g., in a physical downlink control channel (PDCCH) or a physical downlink shared channel (PDSCH)), uplink transmissions (e.g., return link transmissions) from a UE 115 to a network entity 105 (e.g., in a physical uplink control channel (PUCCH) or a physical uplink shared channel (PUSCH)), or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ feedback may include an acknowledgment (ACK) indicating that a device successfully received a transmission, or HARQ feedback may include a negative ACK (NACK) indicating that a device failed to successfully receive a transmission. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support beamformed or beam-based communications between a UE 115 and a TRP, such as a TRP that is a component of or associated with a network entity 105. A UE 115 may have access to multiple beams or may be able to generate multiple beams (e.g., using various beam weights), and it may be appropriate for the UE 115 to identify a suitable beam for communicating with a TRP. In some examples, a TCI framework may be implemented to indicate suitable transmission configurations (e.g., beams or beam weights) for communications between a UE 115 and a TRP. The TRP may transmit an indication of a TCI state to the UE 115, and the UE 115 may determine a beam for communicating with the TRP based on the TCI state. For downlink transmissions, a TCI state may correspond to a transmit beam to be used by a TRP for downlink transmissions, and a UE 115 may identify a receive beam to use to receive the downlink transmissions based on the transmit beam. For uplink transmissions, a TCI state may correspond to a receive beam to be used by a TRP to receive uplink transmissions, and a UE 115 may identify a transmit beam to use to transmit the uplink transmissions based on the receive beam.

In some examples, a TRP may configure (e.g., via RRC signaling) a number of candidate TCI states (e.g., M candidate TCI states, where M=64 or M=128) corresponding to different beams for communicating with a UE 115. The TRP may transmit a control message (e.g., a MAC control element (MAC-CE)) indicating a subset of the M candidate TCI states to be activated (e.g., L TCI states to be activated, where L=2^{N} and N is the number of bits used to activate the L TCI states). The activated TCI states may be available for indicating beams for communication between the TRP and the UE 115. Thus, when the TRP transmits DCI to the UE 115 to schedule a downlink transmission to the UE 115 or an uplink transmission from the UE, the TRP may include an indication of a TCI state for the UE 115 to use to determine a beam for receiving the downlink transmission or transmitting the uplink transmission. The indication of the TCI state may be an indication of one TCI state of L active TCI states (e.g., using an N-bit TCI parameter, where N=3 if L=8).

In wireless communications system 100, a TCI state configured at a UE 115 for communicating with a TRP may be a unified TCI state. A unified TCI may be used if a UE 115 is configured to communicate with a single TRP (e.g., for a single TRP case). A unified TCI state may be for downlink transmissions only (e.g., applied to at least a UE-dedicated PDSCH or PDCCH), uplink transmissions only (e.g., applied to at least a UE-dedicated PUSCH or PUCCH), or both downlink transmissions and uplink transmissions (e.g., applied to at least a UE-dedicated PDSCH, PDCCH, PUSCH, or PUCCH). Unified TCI states may be configured in RRC pools and may be activated by MAC-CE. One or more DCI formats (e.g., DCI format 1_1 or 1_2) may indicate (e.g., downselect) a unified TCI state from one or more activated unified TCI states. An indicated unified TCI state may be applied to an applicable channel (e.g., for downlink transmissions, uplink transmissions, or both). In some examples, a TRP may indicate a single unified TCI state in DCI (e.g., one unified TCI state is indicated by DCI at a time). In other examples (e.g., when a unified TCI state framework is extended to multiple TRPs), a TRP may indicate multiple unified TCI states in DCI (e.g., more than one TCI state may be indicated by DCI, including one indicated TCI state per TRP).

TABLE 1
Channels or reference signals for which a TCI state
may be applied once activated or indicated

| TCI | | |
|---|---|---|
| state type | Mandatory | Optional (can be configured in RRC) |
| Separate | UE-dedicated PDCCH | Non-UE-dedicated PDCCH and |
| downlink | and PDSCH | PDSCH, aperiodic channel state |
| TCI | | information (CSI) reference signals |
| | | (CSI-RSs) for CSI, aperiodic |
| | | CSI-RSs for beam management |
| Separate | UE-dedicated PUSCH | Sounding reference signals (SRS) for |
| uplink | (dynamic grant and | codebook, non-codebook, or antenna |
| TCI | configured grant-based | switching, aperiodic SRS for beam |
| | PUSCH) and PUCCH | management |
| Joint | UE-dedicated PDCCH | Non-UE-dedicated PDCCH and |
| downlink | and PDSCH, UE- | PDSCH, aperiodic CSI-RSs for CSI, |
| and | dedicated PUSCH | aperiodic CSI-RSs for beam |
| uplink | (dynamic grant and | management, SRSs for codebook, |
| TCI | configured grant-based | non-codebook, or antenna switching, |
| | PUSCH) and PUCCH | aperiodic SRS for beam management |

In wireless communications system 100, multiple TRPs may be deployed to improve spatial diversity of mmW signal reception (e.g., up to two TRPs or more than two TRPs). One or more techniques for generating and transmitting DCI may be supported to facilitate communications between a UE 115 and multiple TRPs.

In one example, multiple TRPs may rely on multiple DCI messages to schedule communications with a UE 115. Each TRP may be associated with a control resource set (CORESET) pool, and each TRP may send its own PDCCH from an associated CORESET to schedule communications with the same TRP. For instance, a DCI from a TRP may schedule communications with the same TRP. TCI states may be associated with each CORESET pool or TRP.

In another example, multiple TRPs may rely on a single DCI message to schedule communications with a UE 115. A single DCI may schedule communications with multiple TRPs. When TCI states are activated via a MAC-CE, the MAC-CE may map multiple (e.g., a pair of) TCI states to a TCI codepoint, with each TCI state being for a TRP. A TCI codepoint may correspond to an element in a list of activated TCI states, where the element is identified by an index in the list of activated TCI states. The TCI codepoint may indicate a single TCI state for a single TRP or multiple TCI states for multiple TRPs. A TRP may use DCI to indicate an index of a TCI codepoint for a communication assignment. If the TCI codepoint indicates multiple TCI states, the multiple TCI states (e.g., each for a different TRP) may be used for communication. In some cases, because a CORESET pool may not be configured (e.g., for a single DCI), a UE 115 may not be able to determine an association between TCI states and TRPs (e.g., when TCI states for multiple TRPs are included in a single DCI message).

In some aspects, to facilitate communications with multiple TRPs, a TCI framework (e.g., unified TCI framework) may be extended (e.g., for a multiple-TRP multiple-DCI case). For instance, if there are M TRPs in total, there may be up to M indicated TCI states at a time, where one TCI state at most is indicated per TRP. A TCI state indication in a DCI provided by a TRP may only be applied to the same TRP. For instance, the DCI from each TRP (e.g., associated with a CORESET pool) may indicate the TCI state associated with the same TRP (e.g., may include a same-TRP TCI state indication). The described extension of a TCI framework for multiple TRPs may be implemented with minimal changes but may rely on same-TRP TCI state (e.g., beam) indications. In some aspects, however, it may be appropriate to support a cross-TRP state indications, where the DCI from a first TRP indicates a TCI state for a second TRP. That is, it may be beneficial to allow cross-TRP TCI state indications for multiple-DCI multiple-TRP cases to achieve lower overhead, lower latency, better reliability (e.g., when another TRP is failing, or more flexibility for network entity scheduling). A first TRP may transmit DCI to a UE 115 indicating a TCI update for a second TRP.

In one example, it may be appropriate to support a cross-TRP state indications for improved reliability. If a configured beam for a second TRP is experiencing low reference signal received power (RSRP), DCI from the second TRP may be unreliable. Under a unified TCI state rule, PDSCHs or PDCCHs may be associated with the same indicated TCI. As such, it may be more reliable for a first TRP to transmit DCI indicating a TCI state for a second TRP. In another example, it may be appropriate to support a cross-TRP TCI state indications for improved flexibility at a network entity 105 or for lower latency or overhead. In some cases, a DCI may indicate an uplink or downlink TCI state change without scheduling any assignments, and a UE may transmit a dedicated ACK for the DCI, resulting in additional overhead. Thus, if a network determines to schedule communications with a first TRP and change a TCI state at a second TRP at the same time, the network may send a single DCI via the first TRP to schedule the communications and change the TCI state (e.g., to indicate both messages). Further, if a CORESET for a second TRP is configured after a COREST for a first TRP (e.g., if the CORESET for the second TRP appears very late), then a network may use an earlier PDCCH opportunity from a first TRP to indicate a TCI state change for a second TRP.

The wireless communications system 100 may support efficient techniques for utilizing cross-TRP TCI state indications. A first TRP may transmit DCI to a UE 115 indicating a TCI update for a second TRP. The DCI may (e.g., additionally or alternatively) indicate a TCI update for the first TRP. The DCI also may schedule communication with the first TRP. In some examples, DCI transmitted by a first TRP may always be used to indicate a TCI update for the first TRP. The first TRP may indicate, to a UE 115, whether one or more TCI state indications (e.g., beam update) in a DCI are for the first TRP (e.g., same-TRP TCI state indications), a second TRP (e.g., cross-TRP TCI state indications), or both. Each TRP may have a separate TCI list sharing the same TCI indices (e.g., one index may indicate different TCI states for different TRPs). In one example, each TRP may have its own TCI pool or list (e.g., of activated TCI states), where a list for each TRP is indexed from TCI1 to TCIK. In another example, all TRPs may share the same TCI pool or list (e.g., of activated TCI states).

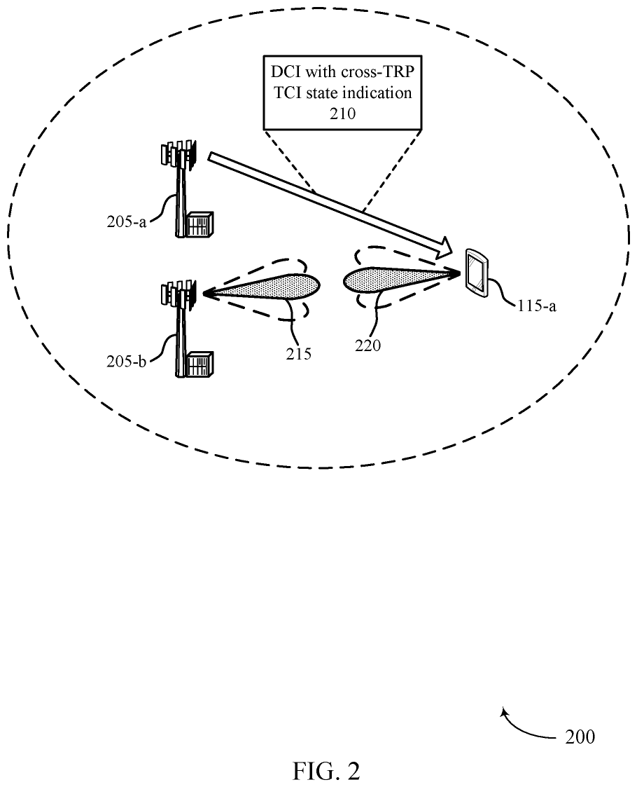

FIG. 2 illustrates an example of a wireless communications system 200 that supports a cross-TRP indication of a transmission configuration indication state in accordance with one or more aspects of the present disclosure. The wireless communications system 200 includes a first TRP 205-a and a second TRP 205-b, which may be examples of network entities or TRPs in accordance with aspects of the present disclosure. The wireless communications system 200 also includes a UE 115-a, which may be an example of a UE in accordance with aspects of the present disclosure. The wireless communications system 200 may implement aspects of the wireless communications system 100. For instance, the wireless communications system 200 may support efficient techniques for indicating TCI states to a UE for communicating with one or more TRPs.

The UE 115-a may be configured to communicate with multiple TRPs, including a first TRP 205-a and a second TRP 205-b. Each TRP of the multiple TRPs may be associated with a TCI state pool in RRC, a TCI state list activated by MAC-CE, or both. For instance, a TCI state list may be activated for each TRP, and the TCI state list may be a subset of a pool of TCI states configured for the TRP or a pool of TCI states configured for all TRPs. A list of TCI states activated for a TRP may be indexed by 1, 2, 3, . . . , M (e.g., for M activated TCI states). In some examples, the first TRP 205-a may transmit DCI to the UE 115-a to indicate one or more TCI states for the UE 115-a to use to communicate with the first TRP 205-a, the second TRP 205-b, or both. In other examples, another TRP or network entity 105 may transmit the DCI 210 to the UE 115-a to indicate the one or more TCI states for the UE 115-a to use to communicate with the first TRP 205-a, the second TRP 205-b, or both. The DCI 210 may or may not schedule communications at the UE 115-a (e.g., include an assignment of resources for communications).

The wireless communications system 200 may support one or more techniques for indicating TRP information associated with the DCI 210. The TRP information may include an indication of a TRP for which a TCI state in the DCI 210 is provided. In one example, the first TRP 205-a may use bits or validation sequences in the DCI 210 to indicate TRP information. The bits may correspond to reserved bits. In another example, the first TRP 205-a may use RRC signaling or MAC-CEs to configure (e.g., preconfigure) a linkage between TCI states for the first TRP 205-a and the second TRP 205-b. For instance, for the first TRP 205-a, a MAC-CE may activate a first TCI codepoint corresponding to a TCI state for the first TRP 205-a and a second TCI codepoint corresponding to a TCI state for the first TRP 205-a and a TCI state for the second TRP 205-b.

If a first TCI codepoint is activated or indicated by the DCI 210, the DCI 210 may include the TCI state for the first TRP 205-a. If a second TCI codepoint is activated or indicated by the DCI 210, the DCI 210 may include the TCI state for the first TRP 205-a and the TCI state for the second TRP 205-b. In some examples, the DCI 210 may indicate or activate a TCI codepoint corresponding to multiple TCI states for multiple TRPs, and the DCI 210 may further indicate which of the multiple TCI states for the multiple TRPs are to be applied. Applying a TCI state may correspond to communicating with a TRP using a beam corresponding to the TCI state. In some examples, a UE 115 may apply a TCI state (e.g., communicate on corresponding channels or transmit or receive reference signals in accordance with the TCI state) for a configured application time. A TCI state (e.g., beam) application time may be common for multiple TRPs (e.g., the first TRP 205-a and the second TRP 205-b) or separate for different TRPs and determined when a DCI includes TCI state indications applying to the multiple TRPs.

In some examples, the first TRP 205-a may use bits in the DCI 210 to indicate a TRP for which a TCI state in the DCI 210 is provided. In one example, a single bit in the DCI 210 may indicate whether a TCI field in the DCI 210 is for the first TRP 205-a or the second TRP 205-b. The TCI field for a TRP may include an index to a list of TCI states activated for the TRP. For instance, if the TCI field is for the first TRP 205-a, a TCI index indicated by the TCI field may indicate a TCI state in a list of TCI states activated for the first TRP 205-a. Similarly, if the TCI field is for the second TRP 205-a, a TCI index indicated by the TCI field may indicate a TCI state in a list of TCI states activated for the second TRP 205-b. In another example, a TCI field may be extended into multiple (e.g., two) subfields, where each subfield corresponds to or is designated to a different TRP. A reserved index may be used or indicated in a subfield when the subfield is not used to indicate a TCI state for a TRP. A DCI format may be changed or adapted to facilitate an extension of the TCI field for multiple TRPs.

In some examples, the first TRP 205-a may use validation sequences in the DCI 210 to indicate a TRP for which a TCI state in the DCI 210 is provided. In some cases, when certain DCI formats (e.g., DCI format 1_1 or DCI format 1_2) are used to indicate TCI states (e.g., beam updates) without an assignment (e.g., a downlink assignment), a special sequence may be included in predefined fields in a DCI. When the special sequence matches a validation sequence, a UE 115 may determine that the DCI includes only a TCI state indication. One or more validation sequences may be assigned for indicating a TRP for which a TCI state in the DCI 210 is provided. A first validation sequence may indicate that the DCI 210 includes a TCI state indication for the first TRP 205-a (e.g., a same-TRP TCI state indication). A second validation sequence may indicate that the DCI 210 includes a TCI state indication for the second TRP 205-b (e.g., a cross-TRP TCI state indication). A third validation sequence may indicate that the DCI 210 includes TCI state indications for the first TRP 205-a and the second TRP 205-b (e.g., beam indications for both beam). The first TRP 205-a may use a reserved field to indicate the TCI state for another TRP (e.g., the second TRP 205-b).

In some examples, the first TRP 205-a may rely on linkages between TCI states to indicate a TRP for which a TCI state in the DCI 210 is provided. In one example, the first TRP 205-a (e.g., or a network) may use RRC signaling or a MAC-CE to configure a linkage between TCI states for different TRPs. In some cases, when a MAC-CE activates TCI codepoints for a TRP, each TCI codepoint may include a TCI state for the TRP and may additionally include or link to a TCI state for another TRP. In some cases, TCI states from different TRP pools may be linked together via RRC signaling. In some cases, a rule may define a linkage between TCI states for different TRPs (e.g., a first TCI state for the first TRP 205-a may be linked to a first TCI state for the second TRP 205-b, or an m-th TCI state for the first TRP 205-a may be linked to an n-th TCI state for the second TRP 205-b). In any case, when a DCI 210 indicates a TCI codepoint corresponding to a TCI state for the first TRP 205-a, the UE 115-a may also determine that the DCI 210 indicates another TCI state (e.g., a linked TCI state) for the second TRP 205-b.

In some examples, the first TRP 205-a may rely on linkages between TCI states and bits or validation sequences in the DCI 210 to indicate a TRP for which a TCI state in the DCI 210 is provided. In the DCI 210 transmitted by the first TRP 205-a, one or more bits or validation sequences may indicate TRPs for which one or more TCI state indications in the DCI 210 are provided. The DCI 210 may include a first TCI state (e.g., an m-th TCI state) for the first TRP 205-a, and the first TCI state may be linked to a second TCI state (e.g., an n-th TCI state) for the second TRP 205-b. The DCI 210 may further indicate whether to apply the first TCI state for the first TRP 205-a, the second TCI state for the second TRP 205-b, or both.

If one or more bits or validation sequences in the DCI 210 indicate that the DCI 210 includes a TCI state for the first TRP 205-a, the UE 115-a may apply the first TCI state for the first TRP 205-a. For instance, if the DCI 210 is associated with only a same-TRP TCI state indication, then an m-th TCI state in a list configured for the first TRP 205-a is indicated by the DCI 210. If one or more bits or validation sequences in the DCI 210 indicate that the DCI 210 includes a TCI state for the second TRP 205-b, the UE 115-a may apply the second TCI state for the second TRP 205-a. For instance, if the DCI 210 is associated with only a cross-TRP TCI state indication, then an n-th TCI state in a list configured for the second TRP 205-b is indicated by the DCI 210. If one or more bits or validation sequences in the DCI 210 indicate that the DCI 210 includes TCI states for the first TRP 205-a and the second TRP 205-b, the UE 115-a may apply the first TCI state for the first TRP 205-a and the second TCI state for the second TRP 205-a. For instance, if the DCI 210 is associated with both TRPs, then an m-th TCI state in a list configured for the first TRP 205-a is indicated by the DCI 210 and an n-th TCI state in a list configured for the second TRP 205-a is indicated by the DCI 210.

In the example of FIG. 2, the first TRP 205-a may transmit the DCI 210 with a cross-TRP TCI state indication. That is, the DCI 210, transmitted by the first TRP 205-a, may indicate a TCI state for communications with the second TRP 205-b. The TCI state may correspond to a beam 215 to be used by the second TRP 205-b for communicating with the UE 115-a, and the UE 115-a may determine the beam 220 for communicating with the second TRP 205-b based on the cross-TRP TCI state indication or the beam 215. In some examples, the DCI 210 may also include a same-TRP TCI state indication. That is, the DCI 210, transmitted by the first TRP 205-a, may indicate a TCI state for communications with the first TRP 205-a. The TCI state may correspond to another beam to be used by the first TRP 205-a for communicating with the UE 115-a, and the UE 115-a may determine a beam for communicating with the first TRP 205-a based on the same-TRP TCI state indication or the other beam.

In some examples, the UE 115-a may transmit a capability indication to a network (e.g., to the first TRP 205-a) indicating that the UE 115-a is capable of receiving cross-TRP TCI state indications. In such examples, the UE 115-a may receive the DCI 210 with the cross-TRP TCI state indication from the first TRP 205-a based on transmitting the capability indication. In some examples, the UE 115-a may receive an indication from a network (e.g., the TRP 205-a) that a utilization of cross-TRP TCI state indications is activated. For instance, a network entity may (e.g., via RRC signaling) turn on (e.g., activate) or turn off (e.g., deactivate) the utilization of cross-TRP TCI state indications. In such examples, the UE 115-a may receive the DCI 210 with the cross-TRP TCI state indication from the first TRP 205-a based on the utilization of cross-TRP TCI state indications being activated. In some examples, a cross-TRP TCI state indication may only be included in a DCI without an assignment. (e.g., since there may be more unused bits in such a DCI which may be used to indicate further information, such as a TRP for which a TCI state indication is provided or additional TCI state indications for other TRPs).

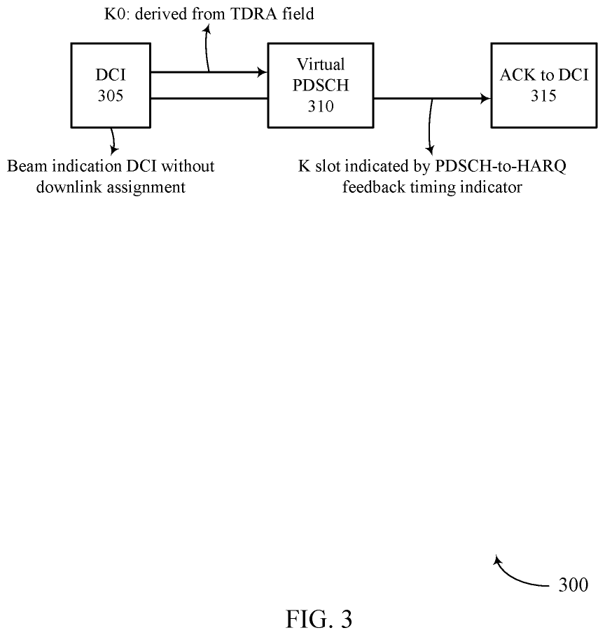

FIG. 3 shows a block diagram 300 of signaling supporting DCI without an assignment in accordance with one or more aspects of the present disclosure. A DCI 305 of format 1_1 or 1_2 may be used to indicate a TCI state with or without scheduling any assignments. A DCI 305 including a downlink assignment may include a TCI field indicating a TCI state for the downlink assignment. A DCI 305 without a downlink assignment may include a TCI field indicating a TCI state for another downlink assignment (e.g., a same-TRP or cross-TRP TCI state indication). A DCI 305 without an assignment may include cyclic redundancy check (CRC) bits scrambled by a cell-specific radio network temporary identifier (CS-RNTI). The DCI 305 without the assignment may also include redundancy version values set to one, modulation and coding scheme (MCS) values set to one, a new data indicator (NDI) value set to zero, or frequency-domain resource allocation (FDRA) values set to ones for FDRA type one or to zeros for a dynamic switch. A TCI field in the DCI 305 without an assignment may be used to indicate a TCI state identifier. A PDSCH-to-HARQ feedback timing indicator field (e.g., if present) may be used to indicate a time offset from the DCI 305 to an ACK 315 in a PUCCH. For a type-one HARQ-ACK codebook, the TDRA field in the DCI 305 may be used to derive a location of a virtual PDSCH 310, which may further be used to determine a location for the ACK information (e.g., the ACK 315) in a HARQ-ACK codebook.

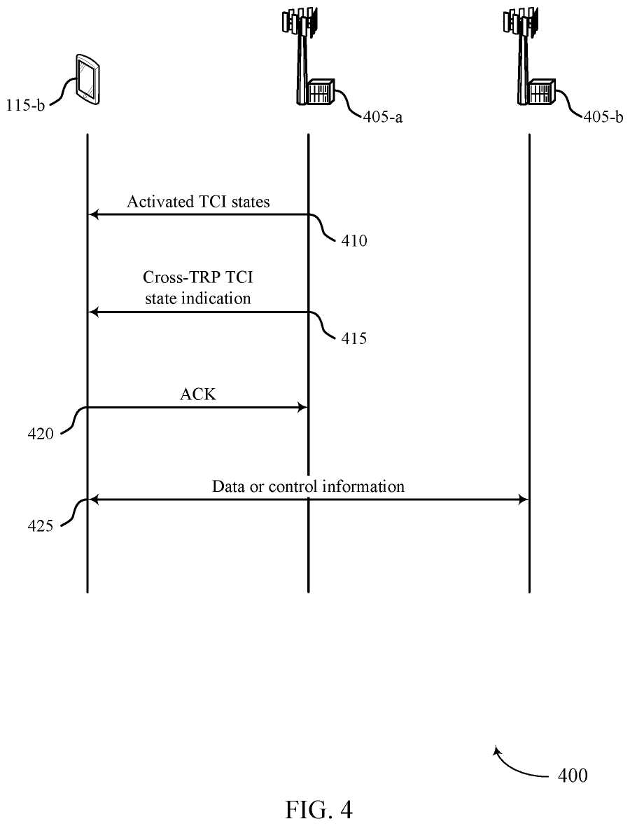

FIG. 4 illustrates an example of a process flow 400 that supports a cross-TRP indication of a transmission configuration indication state in accordance with one or more aspects of the present disclosure. The process flow 400 includes a first TRP 405-a and a second TRP 405-b, which may be example of network entities or TRPs in accordance with aspects of the present disclosure. The process flow 400 also includes a UE 115-b, which may be an example of a UE in accordance with aspects of the present disclosure. The process flow 400 may implement aspects of the wireless communications system 100 or the wireless communications system 200. For instance, the process flow 400 may support efficient techniques for indicating TCI states to a UE for communicating with one or more TRPs.

In the following description of the process flow 400, the signaling exchanged between the UE 115-b, the first TRP 405-a, and the second TRP 405-b may be exchanged in a different order than the example order shown, or the operations performed by the UE 115-b, the first TRP 405-a, and the second TRP 405-b may be performed in different orders or at different times. Some operations may also be omitted from the process flow 400, and other operations may be added to the process flow 400.

At 410, the first TRP 405-a may transmit, and the UE 115-b may receive, an indication (e.g., in a MAC-CE) of activated TCI states for communicating with the first TRP 405-a and the second TRP 405-b. The activated TCI states may include a first set of TCI states activated for the first TRP 405-a and a second set of TCI states activated for the second TRP 405-b. In some examples, the UE 115-b may receive (e.g., via RRC signaling) an indication of a first list (e.g., pool) of TCI states configured for the first TRP 405-a and an indication of a second list of TCI states configured for the second TRP 405-b. In such examples, the first TRP 405-a may select the first set of TCI states to activate for the first TRP 405-a from the first list of TCI states, and the second TRP 405-b may select the second set of TCI states to activate for the second TRP 405-b from the second list of TCI states. In some other examples, the UE 115-b may receive (e.g., via RRC signaling) an indication of a single list of TCI states configured for all TRPs. In such examples, the first TRP 405-a may select the first set of TCI states to activate for the first TRP 405-a from the single list of TCI states, and the second TRP 405-b may select the second set of TCI states to activate for the second TRP 405-b from the single list of TCI states.

At 415, the first TRP 405-a may transmit, and the UE 115-b may receive, in DCI, an indication of a first TCI state for communicating with the second TRP 405-b. The indication, from the first TRP 405-a, of the first TCI state, for communicating with the second TRP 405-b, may be referred to as a cross-TRP TCI state indication. The first TCI state may be from the second set of TCI states activated for the second TRP 405-b. In some examples, the DCI may include the indication of the first TCI state without scheduling communications. For instance, the DCI may be without assignment (e.g., may not include an assignment) as described with reference to FIG. 3. In some examples, a common application time or separate application times may be configured for communicating with the second TRP in accordance with the first TCI state and communicating with the first TRP in accordance with a second TCI state.

In some examples, the DCI may include a field for one or more TCI states, and the DCI may also include an indicator of whether each of the one or more TCI states are for communicating with the first TRP 405-a, the second TRP 405-b, or some other TRP. The indicator may include one or more bits or a validation sequence. For instance, the first TRP 405-a may transmit, and the UE 115-b may receive, in the DCI, a first indicator to apply the first TCI state for communicating with the second TRP 405-b. The first indicator may be different from a second indicator to apply a second TCI state for communicating with the first TRP 405-a, the second TCI state being from the first set of TCI states activated for the first TRP 405-b. The first indicator may also be different from a third indicator to apply the first TCI state for communicating with the second TRP 405-b and the second TCI state for communicating with the first TRP 405-a.

In some examples, the DCI may include a different field carrying a TCI state for each of one or more TRPs (e.g., including the first TRP 405-a and the second TRP 405-b). For instance, the first TRP 405-a may transmit, and the UE 115-b may receive, in the DCI, a first field including the first TCI state. The first field including the first TCI state may be dedicated to the second TRP 405-b and may be different from a second field in the DCI dedicated to the first TRP 405-a. The first TRP 405-a may transmit, and the UE 115-b may receive, in the second field of the DCI, a reserved index indicating that the DCI fails to include an indication of a second TCI state for communicating with the first TRP 405-a, the second TCI state being from the first set of TCI states activated for the first TRP 405-b.

In some examples, the first TRP 405-a may transmit, and the UE 115-b may receive, in the DCI, an indication of a second TCI state for communicating with the first TRP 405-a, the second TCI state being from the first set of TCI state activated for the first TRP 405-b. The UE 115-b may then determine the first TCI state for communicating with the second TRP based on the second TCI state for communicating with the first TRP. The first TCI state may be linked to the second TCI state, and the UE 115-b may determine the second TCI state based on the first TCI state being linked to the second TCI state. Thus, the DCI may implicitly indicate the first TCI state by explicitly indicating the second TCI state. In some examples, the first TRP 405-a may transmit, and the UE 115-b may receive, an indication that the second TCI state is linked to the first TCI state. In some examples, the second TCI state may be linked to the first TCI state according to a predefined rule.

In some examples, when the DCI indicates multiple TCI states for multiple TRPs (e.g., via one or more links between TCI states), the DCI may further include an indicator of whether to apply one or more of the indicated TCI states for one or more of the TRPs. For instance, if the DCI indicates the first TCI state and the second TCI state, the first TRP 405-a may transmit, and the UE 115-b may receive, in the DCI, an indicator to apply the first TCI state, the second TCI state, or both. In some examples, the indicator may be a first indicator to apply the first TCI state for communicating with the second TRP 405-b. In some examples, the indicator may be a second indicator to apply the second TCI state for communicating with the first TRP 405-a. In some examples, the indicator may be a third indicator to apply the first TCI state for communicating with the second TRP 405-b and the second TCI state for communicating with the first TRP 405-a.

At 420, the UE 115-b may transmit an ACK to the first TRP 405-a for the DCI carrying the indication of the first TCI state.

At 425, the UE 115-b may communicate with the second TRP 405-b in accordance with the first TCI state. For instance, the UE 115-b may select a beam for communicating with the second TRP 405-b based on the first TCI state, and the UE 115-b may exchange (e.g., transmit or receive) data or control information with the second TRP 405-b using the selected beam. In some example, the DCI with the cross-TRP TCI state indication received by the UE 115-b at 415 may also include a second TCI state for communicating with the first TRP 405-a. The second TCI state may be selected from the first set of TCI states activated for the first TRP 405-a. The UE 115-b may then communicate with the first TRP 405-a in accordance with the second TCI state. For instance, the UE 115-b may select a beam for communicating with the first TRP 405-a based on the second TCI state, and the UE 115-b may exchange (e.g., transmit or receive) data or control information with the first TRP 405-a using the selected beam.

In some aspects described herein, the UE 115-b may be configured with a respective list of TCI states activated for each TRP. In some examples, however, the UE 115-b may be configured with a single list of TCI states activated for all TRPs. When TCI states across all TRPs are configured or activated in a same list, a network entity (e.g., the first TRP 405-a) may indicate a TCI state identifier to the UE 115-b, and the TCI state identifier may indicate TRP information (e.g., a TRP for which the TCI state identifier is provided). For instance, the list of TCI states activated for all TRPs may include a respective sub-list for each TRP, and, if the UE 115-b receives a TCI state indication including an index to the list of TCI states, the sub-list including the index may correspond to the TRP for which the UE 115-b is to apply the TCI state indication. When cross-TRP TCI state indications are not allowed, then a DCI received from the first TRP 405-a may only include a TCI state indication associated with the first TRP 405-a or a same TRP (e.g., a TCI state indication including an index to a sub-list corresponding to the first TRP 405-a). Otherwise, there may be no limitation on the TCI identifier that may be included in DCI by the first TRP 405-a. If a single list of TCI states is activated for all TRPs (e.g., including TCI states for all TRPs), a TCI field may include additional bits compared to a same number of TCI states being configured in respective lists for respective TRPs.

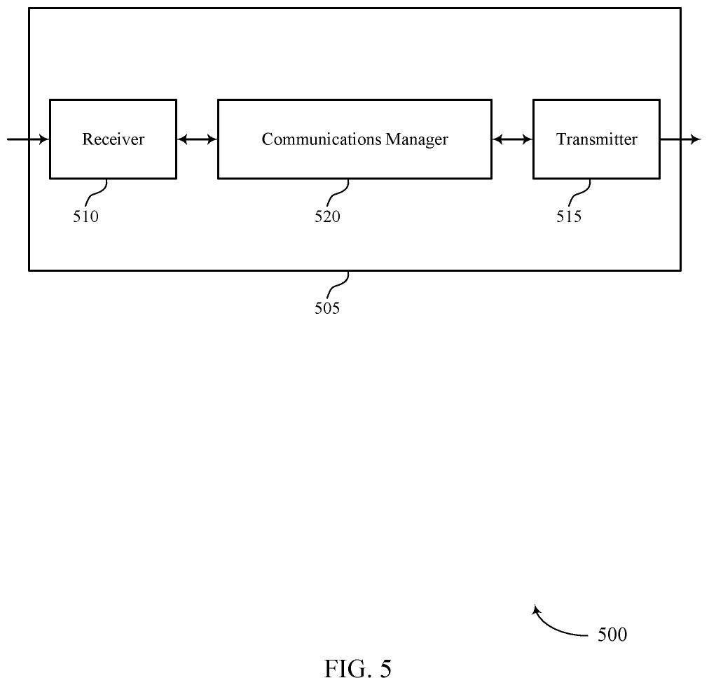

FIG. 5 shows a block diagram 500 of a device 505 that supports a cross-TRP indication of a transmission configuration indication state in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to a cross-TRP indication of a transmission configuration indication state). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to a cross-TRP indication of a transmission configuration indication state). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of a cross-TRP indication of a transmission configuration indication state as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 may be configured as or otherwise support a means for receiving an indication of a first set of transmission configuration indication states activated for a first transmission and reception point and a second set of transmission configuration indication states activated for a second transmission and reception point. The communications manager 520 may be configured as or otherwise support a means for receiving, in downlink control information from the first transmission and reception point, an indication of a first transmission configuration indication state for communicating with the second transmission and reception point, the first transmission configuration indication state being from the second set of transmission configuration states. The communications manager 520 may be configured as or otherwise support a means for communicating with the second transmission and reception point in accordance with the first transmission configuration indication state.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources. The device 505 may receive a cross-TRP TCI state indication from a first TRP and may select a beam for communicating with a second TRP based on the cross-TRP TCI state indication. The use of the cross-TRP TCI state indication may allow for reduced processing and reduced power consumption since, for example, the first TRP may transmit a cross-TRP TCI state indication to the device 505 when the first TRP has a more reliable connection to the device 505 than the second TRP (e.g., preventing unnecessary retransmissions of a TCI state indication). The use of the cross-TRP TCI state indication may also allow for more efficient utilization of communication resources since, for example, the first TRP may include a cross-TRP TCI state indication in DCI already being transmitted to the device 505.

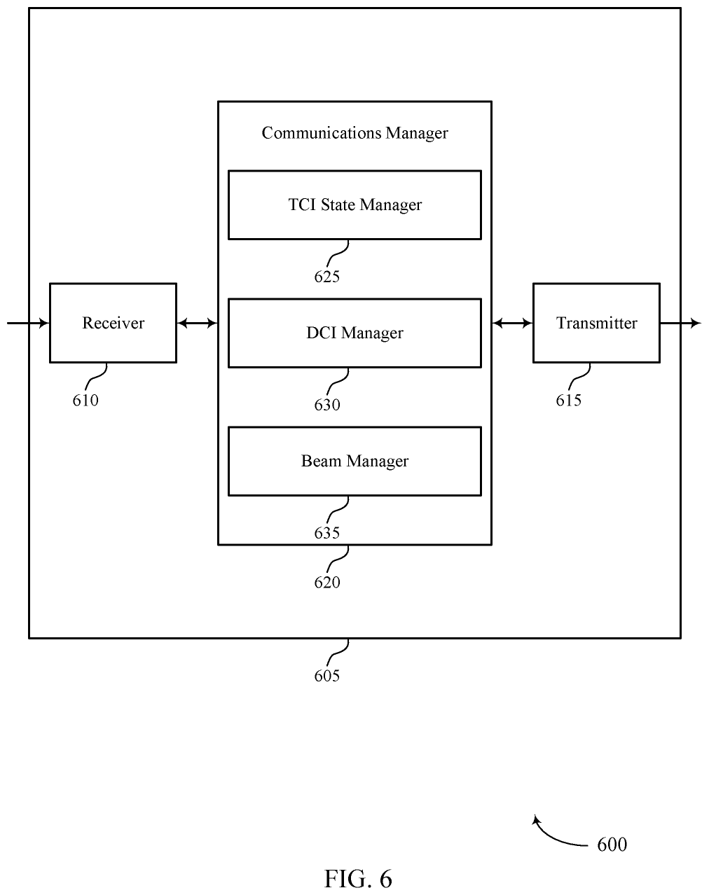

FIG. 6 shows a block diagram 600 of a device 605 that supports a cross-TRP indication of a transmission configuration indication state in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to a cross-TRP indication of a transmission configuration indication state). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to a cross-TRP indication of a transmission configuration indication state). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of a cross-TRP indication of a transmission configuration indication state as described herein. For example, the communications manager 620 may include a TCI state manager 625, a DCI manager 630, a beam manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The TCI state manager 625 may be configured as or otherwise support a means for receiving an indication of a first set of transmission configuration indication states activated for a first transmission and reception point and a second set of transmission configuration indication states activated for a second transmission and reception point. The DCI manager 630 may be configured as or otherwise support a means for receiving, in downlink control information from the first transmission and reception point, an indication of a first transmission configuration indication state for communicating with the second transmission and reception point, the first transmission configuration indication state being from the second set of transmission configuration states. The beam manager 635 may be configured as or otherwise support a means for communicating with the second transmission and reception point in accordance with the first transmission configuration indication state.

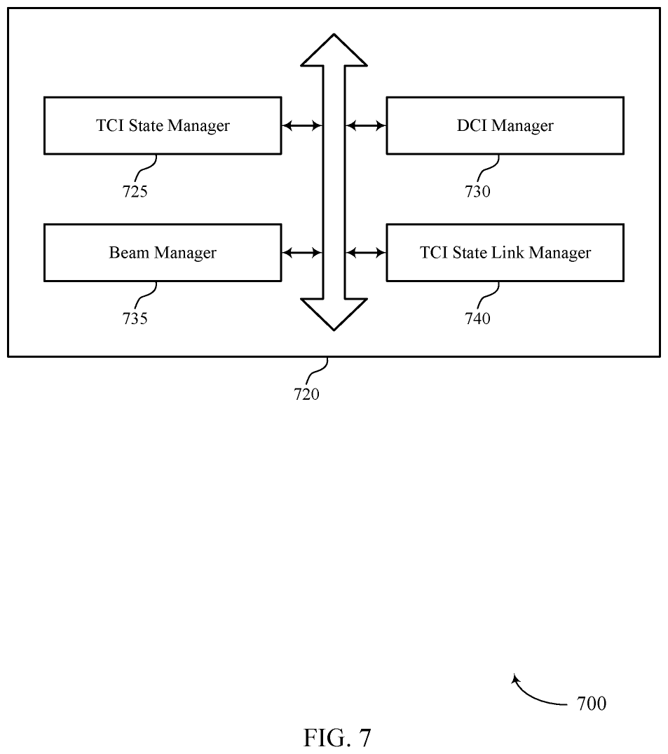

FIG. 7 shows a block diagram 700 of a communications manager 720 that supports a cross-TRP indication of a transmission configuration indication state in accordance with one or more aspects of the present disclosure. The communications manager 720 may be an example of aspects of a communications manager 520, a communications manager 620, or both, as described herein. The communications manager 720, or various components thereof, may be an example of means for performing various aspects of a cross-TRP indication of a transmission configuration indication state as described herein. For example, the communications manager 720 may include a TCI state manager 725, a DCI manager 730, a beam manager 735, a TCI state link manager 740, or any combination thereof. Each of these components may communicate, directly or indirectly, with one another (e.g., via one or more buses).

The communications manager 720 may support wireless communication in accordance with examples as disclosed herein. The TCI state manager 725 may be configured as or otherwise support a means for receiving an indication of a first set of transmission configuration indication states activated for a first transmission and reception point and a second set of transmission configuration indication states activated for a second transmission and reception point. The DCI manager 730 may be configured as or otherwise support a means for receiving, in downlink control information from the first transmission and reception point, an indication of a first transmission configuration indication state for communicating with the second transmission and reception point, the first transmission configuration indication state being from the second set of transmission configuration states. The beam manager 735 may be configured as or otherwise support a means for communicating with the second transmission and reception point in accordance with the first transmission configuration indication state.

In some examples, the downlink control information further includes an indication of a second transmission configuration indication state for communicating with the first transmission and reception point, and the beam manager 735 may be configured as or otherwise support a means for communicating with the first transmission and reception point in accordance with the second transmission configuration indication state.

In some examples, the DCI manager 730 may be configured as or otherwise support a means for receiving, in the downlink control information, a first indicator to apply the first transmission configuration indication state for communicating with the second transmission and reception point.

In some examples, the first indicator is different from a second indicator to apply a second transmission configuration indication state for communicating with the first transmission and reception point, the second transmission configuration indication state being from the first set of transmission configuration indication states. In some examples, the first indicator is different from a third indicator to apply the first transmission configuration indication state for communicating with the second transmission and reception point and the second transmission configuration indication state for communicating with the first transmission and reception point.

In some examples, the first indicator includes one or more bits or a validation sequence.

In some examples, the DCI manager 730 may be configured as or otherwise support a means for receiving, in the downlink control information, a first field including the first transmission configuration indication state, the first field being dedicated to the second transmission and reception point and being different from a second field in the downlink control information dedicated to the first transmission and reception point.

In some examples, the DCI manager 730 may be configured as or otherwise support a means for receiving, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

In some examples, the DCI manager 730 may be configured as or otherwise support a means for receiving, in the downlink control information, an indication of a second transmission configuration indication state for communicating with the first transmission and reception point, the second transmission configuration indication state being from the first set of transmission configuration indication states. In some examples, the TCI state link manager 740 may be configured as or otherwise support a means for determining the first transmission configuration indication state for communicating with the second transmission and reception point based on the second transmission configuration indication state for communicating with the first transmission and reception point.

In some examples, the TCI state link manager 740 may be configured as or otherwise support a means for receiving an indication that the second transmission configuration indication state is linked to the first transmission configuration indication state.

In some examples, the second transmission configuration indication state is linked to the first transmission configuration indication state according to a predefined rule.

In some examples, the DCI manager 730 may be configured as or otherwise support a means for receiving, in the downlink control information, a first indicator to apply the first transmission configuration indication state for communicating with the second transmission and reception point.

In some examples, the DCI manager 730 may be configured as or otherwise support a means for receiving, in the downlink control information, a third indicator to apply the first transmission configuration indication state for communicating with the second transmission and reception point and the second transmission configuration indication state for communicating with the first transmission and reception point.

In some examples, a common application time or separate application times are configured for communicating with the second transmission and reception point in accordance with the first transmission configuration indication state and communicating with the first transmission and reception point in accordance with a second transmission configuration indication state.

In some examples, the downlink control information includes the indication of the first transmission configuration indication state without scheduling communications.

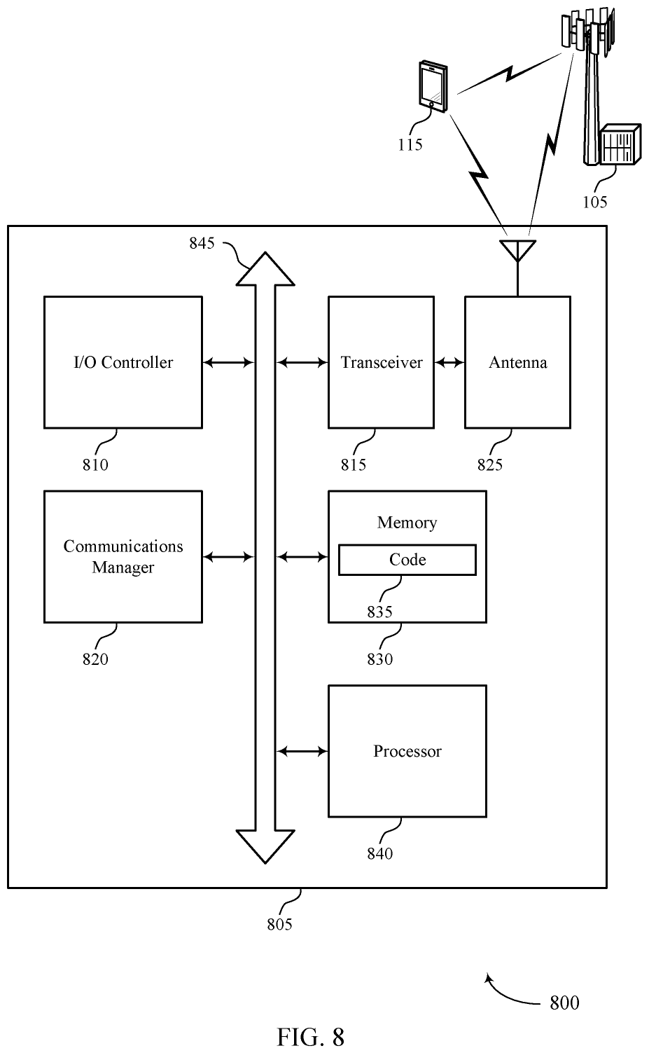

FIG. 8 shows a diagram of a system 800 including a device 805 that supports a cross-TRP indication of a transmission configuration indication state in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting a cross-TRP indication of a transmission configuration indication state). For example, the device 805 or a component of the device 805 may include a processor 840 and memory 830 coupled with or to the processor 840, the processor 840 and memory 830 configured to perform various functions described herein.

The communications manager 820 may support wireless communication in accordance with examples as disclosed herein. For example, the communications manager 820 may be configured as or otherwise support a means for receiving an indication of a first set of transmission configuration indication states activated for a first transmission and reception point and a second set of transmission configuration indication states activated for a second transmission and reception point. The communications manager 820 may be configured as or otherwise support a means for receiving, in downlink control information from the first transmission and reception point, an indication of a first transmission configuration indication state for communicating with the second transmission and reception point, the first transmission configuration indication state being from the second set of transmission configuration states. The communications manager 820 may be configured as or otherwise support a means for communicating with the second transmission and reception point in accordance with the first transmission configuration indication state.

By including or configuring the communications manager 820 in accordance with examples as described herein, the device 805 may support techniques for reduced processing, reduced power consumption, and more efficient utilization of communication resources. The device 805 may receive a cross-TRP TCI state indication from a first TRP and may select a beam for communicating with a second TRP based on the cross-TRP TCI state indication. The use of the cross-TRP TCI state indication may allow for reduced processing and reduced power consumption since, for example, the first TRP may transmit a cross-TRP TCI state indication to the device 805 when the first TRP has a more reliable connection to the device 805 than the second TRP (e.g., preventing unnecessary retransmissions of a TCI state indication). The use of the cross-TRP TCI state indication may also allow for more efficient utilization of communication resources since, for example, the first TRP may include a cross-TRP TCI state indication in DCI already being transmitted to the device 805.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of a cross-TRP indication of a transmission configuration indication state as described herein, or the processor 840 and the memory 830 may be otherwise configured to perform or support such operations.

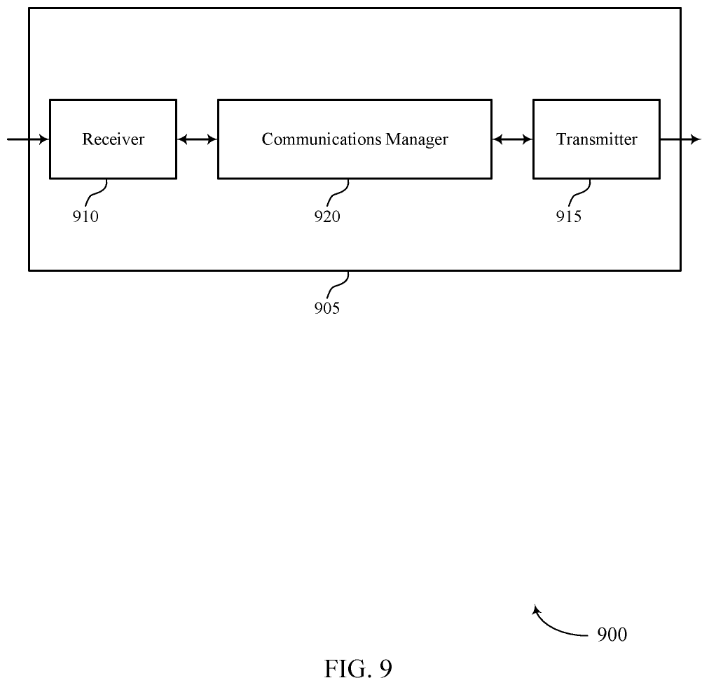

FIG. 9 shows a block diagram 900 of a device 905 that supports a cross-TRP indication of a transmission configuration indication state in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of a cross-TRP indication of a transmission configuration indication state as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 may be configured as or otherwise support a means for transmitting an indication of a first set of transmission configuration indication states activated for a first transmission and reception point and a second set of transmission configuration indication states activated for a second transmission and reception point. The communications manager 920 may be configured as or otherwise support a means for transmitting, in downlink control information from the first transmission and reception point, an indication of a first transmission configuration indication state for communicating with the second transmission and reception point, the first transmission configuration indication state being from the second set of transmission configuration states.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources. The device 905 may transmit, from a first TRP, a cross-TRP TCI state indication for a UE to use to select a beam for communicating with a second TRP. The use of the cross-TRP TCI state indication may allow for reduced processing and reduced power consumption since, for example, the first TRP may transmit a cross-TRP TCI state indication to the UE when the first TRP has a more reliable connection to the UE than the second TRP (e.g., preventing unnecessary retransmissions of a TCI state indication). The use of the cross-TRP TCI state indication may also allow for more efficient utilization of communication resources since, for example, the first TRP may include a cross-TRP TCI state indication in DCI already being transmitted to the UE.

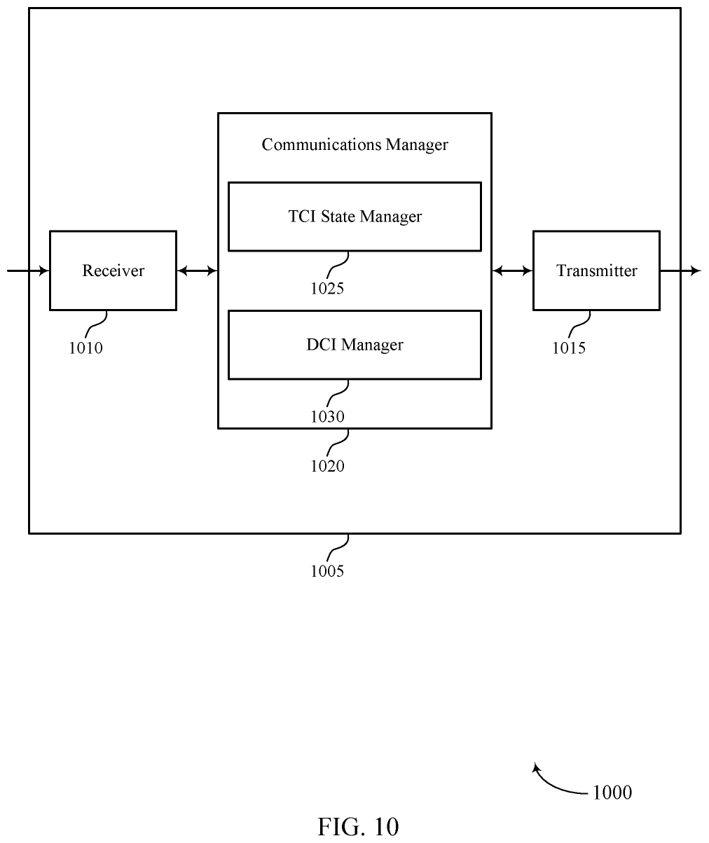

FIG. 10 shows a block diagram 1000 of a device 1005 that supports a cross-TRP indication of a transmission configuration indication state in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of a cross-TRP indication of a transmission configuration indication state as described herein. For example, the communications manager 1020 may include a TCI state manager 1025 a DCI manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The TCI state manager 1025 may be configured as or otherwise support a means for transmitting an indication of a first set of transmission configuration indication states activated for a first transmission and reception point and a second set of transmission configuration indication states activated for a second transmission and reception point. The DCI manager 1030 may be configured as or otherwise support a means for transmitting, in downlink control information from the first transmission and reception point, an indication of a first transmission configuration indication state for communicating with the second transmission and reception point, the first transmission configuration indication state being from the second set of transmission configuration states.

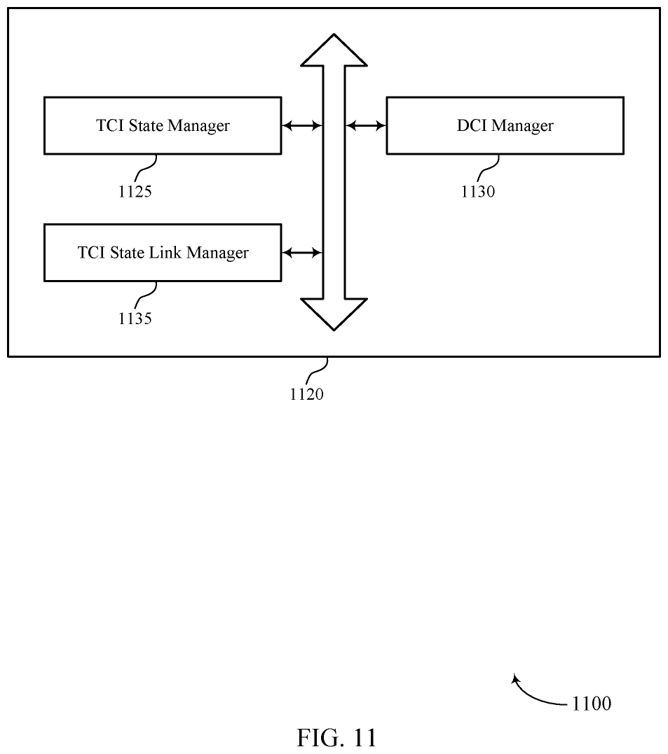

FIG. 11 shows a block diagram 1100 of a communications manager 1120 that supports a cross-TRP indication of a transmission configuration indication state in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of a cross-TRP indication of a transmission configuration indication state as described herein. For example, the communications manager 1120 may include a TCI state manager 1125, a DCI manager 1130, a TCI state link manager 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The TCI state manager 1125 may be configured as or otherwise support a means for transmitting an indication of a first set of transmission configuration indication states activated for a first transmission and reception point and a second set of transmission configuration indication states activated for a second transmission and reception point. The DCI manager 1130 may be configured as or otherwise support a means for transmitting, in downlink control information from the first transmission and reception point, an indication of a first transmission configuration indication state for communicating with the second transmission and reception point, the first transmission configuration indication state being from the second set of transmission configuration states.

In some examples, the downlink control information further includes an indication of a second transmission configuration indication state for communicating with the first transmission and reception point, the second transmission configuration indication state being from the first set of transmission configuration indication states.

In some examples, the DCI manager 1130 may be configured as or otherwise support a means for transmitting, in the downlink control information, a first indicator to apply the first transmission configuration indication state for communicating with the second transmission and reception point.

In some examples, the first indicator is different from a second indicator to apply a second transmission configuration indication state for communicating with the first transmission and reception point, the second transmission configuration indication state being from the first set of transmission configuration indication states. In some examples, the first indicator is different from a third indicator to apply the first transmission configuration indication state for communicating with the second transmission and reception point and the second transmission configuration indication state for communicating with the first transmission and reception point.

In some examples, the first indicator includes one or more bits or a validation sequence.

In some examples, the DCI manager 1130 may be configured as or otherwise support a means for transmitting, in the downlink control information, a first field including the first transmission configuration indication state, the first field being dedicated to the second transmission and reception point and being different from a second field in the downlink control information dedicated to the first transmission and reception point.

In some examples, the DCI manager 1130 may be configured as or otherwise support a means for transmitting, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

In some examples, the TCI state link manager 1135 may be configured as or otherwise support a means for transmitting, in the downlink control information, an indication of a second transmission configuration indication state for communicating with the first transmission and reception point, the second transmission configuration indication state being from the first set of transmission configuration indication states, and the second transmission configuration indication state being linked to the first transmission configuration indication state.

In some examples, the TCI state manager 1125 may be configured as or otherwise support a means for transmitting an indication that the second transmission configuration indication state is linked to the first transmission configuration indication state.

In some examples, the second transmission configuration indication state is linked to the first transmission configuration indication state according to a predefined rule.

In some examples, the DCI manager 1130 may be configured as or otherwise support a means for transmitting, in the downlink control information, a first indicator to apply the first transmission configuration indication state for communicating with the second transmission and reception point.

In some examples, the DCI manager 1130 may be configured as or otherwise support a means for transmitting, in the downlink control information, a third indicator to apply the first transmission configuration indication state for communicating with the second transmission and reception point and the second transmission configuration indication state for communicating with the first transmission and reception point.

In some examples, a common application time or separate application times are configured for communicating with the second transmission and reception point in accordance with the first transmission configuration indication state and communicating with the first transmission and reception point in accordance with a second transmission configuration indication state.

In some examples, the downlink control information includes the indication of the first transmission configuration indication state without scheduling communications.

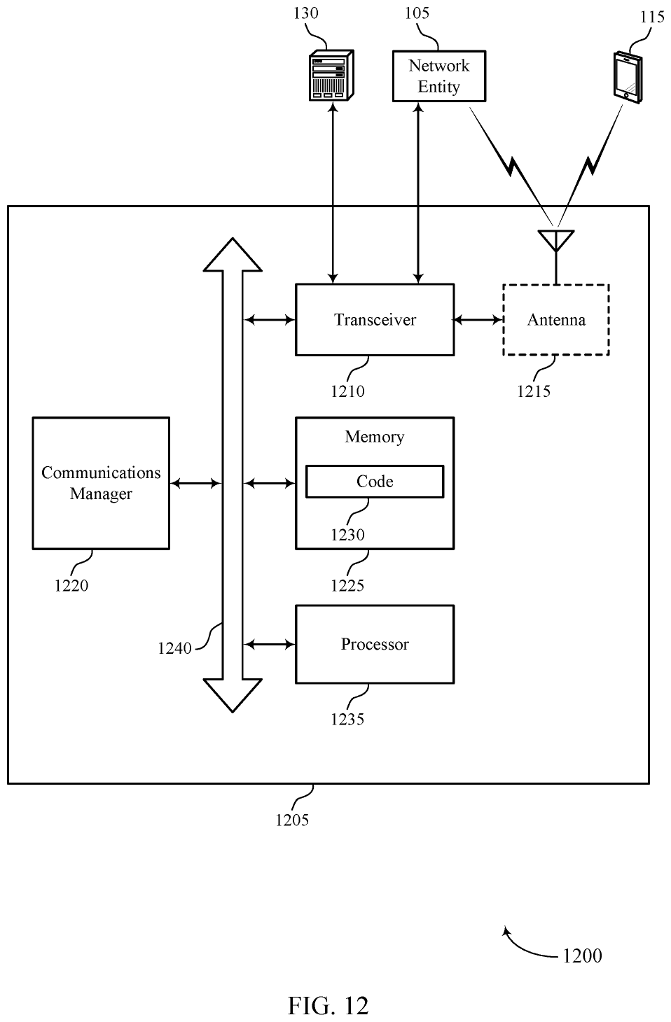

FIG. 12 shows a diagram of a system 1200 including a device 1205 that supports a cross-TRP indication of a transmission configuration indication state in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting a cross-TRP indication of a transmission configuration indication state). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 may be configured as or otherwise support a means for transmitting an indication of a first set of transmission configuration indication states activated for a first transmission and reception point and a second set of transmission configuration indication states activated for a second transmission and reception point. The communications manager 1220 may be configured as or otherwise support a means for transmitting, in downlink control information from the first transmission and reception point, an indication of a first transmission configuration indication state for communicating with the second transmission and reception point, the first transmission configuration indication state being from the second set of transmission configuration states.

By including or configuring the communications manager 1220 in accordance with examples as described herein, the device 1205 may support techniques for reduced processing, reduced power consumption, and more efficient utilization of communication resources. The device 1205 may transmit, from a first TRP, a cross-TRP TCI state indication for a UE to use to select a beam for communicating with a second TRP. The use of the cross-TRP TCI state indication may allow for reduced processing and reduced power consumption since, for example, the first TRP may transmit a cross-TRP TCI state indication to the UE when the first TRP has a more reliable connection to the UE than the second TRP (e.g., preventing unnecessary retransmissions of a TCI state indication). The use of the cross-TRP TCI state indication may also allow for more efficient utilization of communication resources since, for example, the first TRP may include a cross-TRP TCI state indication in DCI already being transmitted to the UE.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of a cross-TRP indication of a transmission configuration indication state as described herein, or the processor 1235 and the memory 1225 may be otherwise configured to perform or support such operations.

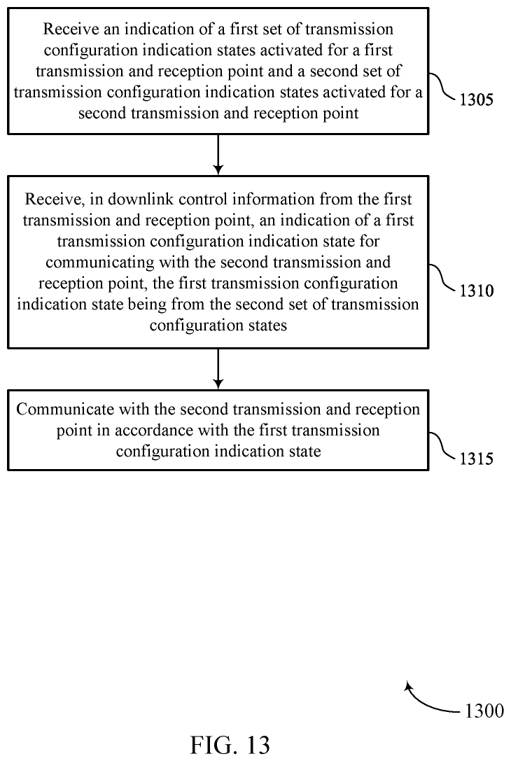

FIG. 13 shows a flowchart illustrating a method 1300 that supports a cross-TRP indication of a transmission configuration indication state in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a first set of transmission configuration indication states activated for a first transmission and reception point and a second set of transmission configuration indication states activated for a second transmission and reception point. The operations of 1305 may be performed in accordance with examples as disclosed herein. In some examples, aspects of the operations of 1305 may be performed by a TCI state manager 725 as described with reference to FIG. 7.

At 1310, the method may include receiving, in downlink control information from the first transmission and reception point, an indication of a first transmission configuration indication state for communicating with the second transmission and reception point, the first transmission configuration indication state being from the second set of transmission configuration states. The operations of 1310 may be performed in accordance with examples as disclosed herein. In some examples, aspects of the operations of 1310 may be performed by a DCI manager 730 as described with reference to FIG. 7.

At 1315, the method may include communicating with the second transmission and reception point in accordance with the first transmission configuration indication state. The operations of 1315 may be performed in accordance with examples as disclosed herein. In some examples, aspects of the operations of 1315 may be performed by a beam manager 735 as described with reference to FIG. 7.

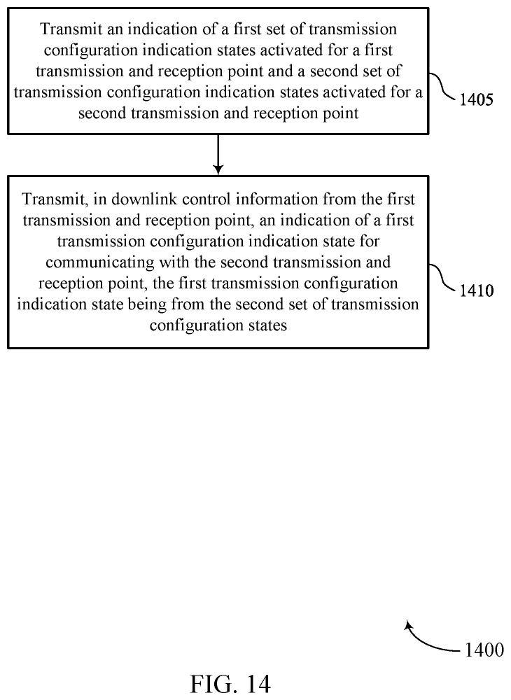

FIG. 14 shows a flowchart illustrating a method 1400 that supports a cross-TRP indication of a transmission configuration indication state in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting an indication of a first set of transmission configuration indication states activated for a first transmission and reception point and a second set of transmission configuration indication states activated for a second transmission and reception point. The operations of 1405 may be performed in accordance with examples as disclosed herein. In some examples, aspects of the operations of 1405 may be performed by a TCI state manager 1125 as described with reference to FIG. 11.

At 1410, the method may include transmitting, in downlink control information from the first transmission and reception point, an indication of a first transmission configuration indication state for communicating with the second transmission and reception point, the first transmission configuration indication state being from the second set of transmission configuration states. The operations of 1410 may be performed in accordance with examples as disclosed herein. In some examples, aspects of the operations of 1410 may be performed by a DCI manager 1130 as described with reference to FIG. 11.

The following provides an overview of aspects of the present disclosure:

Aspect 1: A method for wireless communication, comprising: receiving an indication of a first set of transmission configuration indication states activated for a first transmission and reception point and a second set of transmission configuration indication states activated for a second transmission and reception point; receiving, in downlink control information from the first transmission and reception point, an indication of a first transmission configuration indication state for communicating with the second transmission and reception point, the first transmission configuration indication state being from the second set of transmission configuration states; and communicating with the second transmission and reception point in accordance with the first transmission configuration indication state.

Aspect 2: The method of aspect 1, wherein the downlink control information further comprises an indication of a second transmission configuration indication state for communicating with the first transmission and reception point, the second transmission configuration indication state being from the first set of transmission configuration indication states, the method further comprising: communicating with the first transmission and reception point in accordance with the second transmission configuration indication state.

Aspect 3: The method of any of aspects 1 through 2, further comprising: receiving, in the downlink control information, a first indicator to apply the first transmission configuration indication state for communicating with the second transmission and reception point.

Aspect 4: The method of aspect 3, wherein the first indicator is different from a second indicator to apply a second transmission configuration indication state for communicating with the first transmission and reception point, the second transmission configuration indication state being from the first set of transmission configuration indication states; or the first indicator is different from a third indicator to apply the first transmission configuration indication state for communicating with the second transmission and reception point and the second transmission configuration indication state for communicating with the first transmission and reception point.

Aspect 5: The method of any of aspects 3 through 4, wherein the first indicator comprises one or more bits or a validation sequence.

Aspect 6: The method of any of aspects 1 through 5, further comprising: receiving, in the downlink control information, a first field comprising the first transmission configuration indication state, the first field being dedicated to the second transmission and reception point and being different from a second field in the downlink control information dedicated to the first transmission and reception point.

Aspect 7: The method of aspect 6, further comprising: receiving, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

Aspect 8: The method of any of aspects 1 through 7, further comprising: receiving, in the downlink control information, an indication of a second transmission configuration indication state for communicating with the first transmission and reception point, the second transmission configuration indication state being from the first set of transmission configuration indication states; and determining the first transmission configuration indication state for communicating with the second transmission and reception point based at least in part on the second transmission configuration indication state for communicating with the first transmission and reception point.

Aspect 9: The method of aspect 8, further comprising: receiving an indication that the second transmission configuration indication state is linked to the first transmission configuration indication state.

Aspect 10: The method of any of aspects 8 through 9, wherein the second transmission configuration indication state is linked to the first transmission configuration indication state according to a predefined rule.

Aspect 11: The method of any of aspects 8 through 10, further comprising: receiving, in the downlink control information, a first indicator to apply the first transmission configuration indication state for communicating with the second transmission and reception point.

Aspect 12: The method of any of aspects 8 through 11, further comprising: receiving, in the downlink control information, a third indicator to apply the first transmission configuration indication state for communicating with the second transmission and reception point and the second transmission configuration indication state for communicating with the first transmission and reception point.

Aspect 13: The method of any of aspects 1 through 12, wherein a common application time or separate application times are configured for communicating with the second transmission and reception point in accordance with the first transmission configuration indication state and communicating with the first transmission and reception point in accordance with a second transmission configuration indication state.

Aspect 14: The method of any of aspects 1 through 13, wherein the downlink control information comprises the indication of the first transmission configuration indication state without scheduling communications.

Aspect 15: A method for wireless communication, comprising: transmitting an indication of a first set of transmission configuration indication states activated for a first transmission and reception point and a second set of transmission configuration indication states activated for a second transmission and reception point; and transmitting, in downlink control information from the first transmission and reception point, an indication of a first transmission configuration indication state for communicating with the second transmission and reception point, the first transmission configuration indication state being from the second set of transmission configuration states.

Aspect 16: The method of aspect 15, wherein the downlink control information further comprises an indication of a second transmission configuration indication state for communicating with the first transmission and reception point, the second transmission configuration indication state being from the first set of transmission configuration indication states.

Aspect 17: The method of any of aspects 15 through 16, further comprising: transmitting, in the downlink control information, a first indicator to apply the first transmission configuration indication state for communicating with the second transmission and reception point.

Aspect 18: The method of aspect 17, wherein the first indicator is different from a second indicator to apply a second transmission configuration indication state for communicating with the first transmission and reception point, the second transmission configuration indication state being from the first set of transmission configuration indication states; or the first indicator is different from a third indicator to apply the first transmission configuration indication state for communicating with the second transmission and reception point and the second transmission configuration indication state for communicating with the first transmission and reception point.

Aspect 19: The method of any of aspects 17 through 18, wherein the first indicator comprises one or more bits or a validation sequence.

Aspect 20: The method of any of aspects 15 through 19, further comprising: transmitting, in the downlink control information, a first field comprising the first transmission configuration indication state, the first field being dedicated to the second transmission and reception point and being different from a second field in the downlink control information dedicated to the first transmission and reception point.

Aspect 21: The method of aspect 20, further comprising: transmitting, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

Aspect 22: The method of any of aspects 15 through 21, further comprising: transmitting, in the downlink control information, an indication of a second transmission configuration indication state for communicating with the first transmission and reception point, the second transmission configuration indication state being from the first set of transmission configuration indication states, and the second transmission configuration indication state being linked to the first transmission configuration indication state.

Aspect 23: The method of aspect 22, further comprising: transmitting an indication that the second transmission configuration indication state is linked to the first transmission configuration indication state.

Aspect 24: The method of any of aspects 22 through 23, wherein the second transmission configuration indication state is linked to the first transmission configuration indication state according to a predefined rule.

Aspect 25: The method of any of aspects 22 through 24, further comprising: transmitting, in the downlink control information, a first indicator to apply the first transmission configuration indication state for communicating with the second transmission and reception point.

Aspect 26: The method of any of aspects 22 through 25, further comprising: transmitting, in the downlink control information, a third indicator to apply the first transmission configuration indication state for communicating with the second transmission and reception point and the second transmission configuration indication state for communicating with the first transmission and reception point.

Aspect 27: The method of any of aspects 15 through 26, wherein a common application time or separate application times are configured for communicating with the second transmission and reception point in accordance with the first transmission configuration indication state and communicating with the first transmission and reception point in accordance with a second transmission configuration indication state.

Aspect 28: The method of any of aspects 15 through 27, wherein the downlink control information comprises the indication of the first transmission configuration indication state without scheduling communications.

Aspect 29: An apparatus for wireless communication, comprising a processor; memory coupled with the processor; and instructions stored in the memory and executable by the processor to cause the apparatus to perform a method of any of aspects 1 through 14.

Aspect 30: An apparatus for wireless communication, comprising at least one means for performing a method of any of aspects 1 through 14.

Aspect 31: A non-transitory computer-readable medium storing code for wireless communication, the code comprising instructions executable by a processor to perform a method of any of aspects 1 through 14.

Aspect 32: An apparatus for wireless communication, comprising a processor; memory coupled with the processor; and instructions stored in the memory and executable by the processor to cause the apparatus to perform a method of any of aspects 15 through 28.

Aspect 33: An apparatus for wireless communication, comprising at least one means for performing a method of any of aspects 15 through 28.

Aspect 34: A non-transitory computer-readable medium storing code for wireless communication, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
receive an indication of a first set of transmission configuration indication states activated for a first transmission and reception point and a second set of transmission configuration indication states activated for a second transmission and reception point;
receive, in downlink control information from the first transmission and reception point, an indication of a first transmission configuration indication state for communicating with the second transmission and reception point, the first transmission configuration indication state being from the second set of transmission configuration states; and
communicate with the second transmission and reception point in accordance with the first transmission configuration indication state.

2. The apparatus of claim 1, wherein the downlink control information further comprises an indication of a second transmission configuration indication state for communicating with the first transmission and reception point, and the instructions are further executable by the processor to cause the apparatus to:
communicate with the first transmission and reception point in accordance with the second transmission configuration indication state.

3. The apparatus of claim 1, wherein the instructions are further executable by the processor to cause the apparatus to:
receive, in the downlink control information, a first indicator to apply the first transmission configuration indication state for communicating with the second transmission and reception point.

4. The apparatus of claim 3, wherein:
the first indicator is different from a second indicator to apply a second transmission configuration indication state for communicating with the first transmission and reception point, the second transmission configuration indication state being from the first set of transmission configuration indication states; or
the first indicator is different from a third indicator to apply the first transmission configuration indication state for communicating with the second transmission and reception point and the second transmission configuration indication state for communicating with the first transmission and reception point.

5. The apparatus of claim 3, wherein the first indicator comprises one or more bits or a validation sequence.

6. The apparatus of claim 1, wherein the instructions are further executable by the processor to cause the apparatus to:
receive, in the downlink control information, a first field comprising the first transmission configuration indication state, the first field being dedicated to the second transmission and reception point and being different from a second field in the downlink control information dedicated to the first transmission and reception point.

7. The apparatus of claim 6, wherein the instructions are further executable by the processor to cause the apparatus to:
receive, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

8. The apparatus of claim 1, wherein the instructions are further executable by the processor to cause the apparatus to:
receive, in the downlink control information, an indication of a second transmission configuration indication state for communicating with the first transmission and reception point, the second transmission configuration indication state being from the first set of transmission configuration indication states; and
determine the first transmission configuration indication state for communicating with the second transmission and reception point based at least in part on the second transmission configuration indication state for communicating with the first transmission and reception point.

9. The apparatus of claim 8, wherein the instructions are further executable by the processor to cause the apparatus to:
receive an indication that the second transmission configuration indication state is linked to the first transmission configuration indication state.

10. The apparatus of claim 8, wherein the second transmission configuration indication state is linked to the first transmission configuration indication state according to a predefined rule.

11. The apparatus of claim 8, wherein the instructions are further executable by the processor to cause the apparatus to:
receive, in the downlink control information, a first indicator to apply the first transmission configuration indication state for communicating with the second transmission and reception point.

12. The apparatus of claim 8, wherein the instructions are further executable by the processor to cause the apparatus to:
receive, in the downlink control information, a third indicator to apply the first transmission configuration indication state for communicating with the second transmission and reception point and the second transmission configuration indication state for communicating with the first transmission and reception point.

13. The apparatus of claim 1, wherein a common application time or separate application times are configured for communicating with the second transmission and reception point in accordance with the first transmission configuration indication state and communicating with the first transmission and reception point in accordance with a second transmission configuration indication state.

14. The apparatus of claim 1, wherein the downlink control information comprises the indication of the first transmission configuration indication state without scheduling communications.

15. An apparatus for wireless communication, comprising:
a processor;
memory coupled with the processor; and
instructions stored in the memory and executable by the processor to cause the apparatus to:
transmit an indication of a first set of transmission configuration indication states activated for a first transmission and reception point and a second set of transmission configuration indication states activated for a second transmission and reception point; and
transmit, in downlink control information from the first transmission and reception point, an indication of a first transmission configuration indication state for communicating with the second transmission and reception point, the first transmission configuration indication state being from the second set of transmission configuration states.

16. The apparatus of claim 15, wherein the downlink control information further comprises an indication of a second transmission configuration indication state for communicating with the first transmission and reception point, the second transmission configuration indication state being from the first set of transmission configuration indication states.

17. The apparatus of claim 15, wherein the instructions are further executable by the processor to cause the apparatus to:
transmit, in the downlink control information, a first indicator to apply the first transmission configuration indication state for communicating with the second transmission and reception point.

18. The apparatus of claim 17, wherein:
the first indicator is different from a second indicator to apply a second transmission configuration indication state for communicating with the first transmission and reception point, the second transmission configuration indication state being from the first set of transmission configuration indication states; or
the first indicator is different from a third indicator to apply the first transmission configuration indication state for communicating with the second transmission and reception point and the second transmission configuration indication state for communicating with the first transmission and reception point.

19. The apparatus of claim 17, wherein the first indicator comprises one or more bits or a validation sequence.

20. The apparatus of claim 15, wherein the instructions are further executable by the processor to cause the apparatus to:
transmit, in the downlink control information, a first field comprising the first transmission configuration indication state, the first field being dedicated to the second transmission and reception point and being different from a second field in the downlink control information dedicated to the first transmission and reception point.

21. The apparatus of claim 20, wherein the instructions are further executable by the processor to cause the apparatus to:
transmit, in the second field of the downlink control information, a reserved index indicating that the downlink control information fails to include an indication of a second transmission configuration indication state for communicating with the first transmission and reception point, the second transmission configuration indication state being from the first set of transmission configuration indication states.

22. The apparatus of claim 15, wherein the instructions are further executable by the processor to cause the apparatus to:
transmit, in the downlink control information, an indication of a second transmission configuration indication state for communicating with the first transmission and reception point, the second transmission configuration indication state being from the first set of transmission configuration indication states, and the second transmission configuration indication state being linked to the first transmission configuration indication state.

23. The apparatus of claim 22, wherein the instructions are further executable by the processor to cause the apparatus to:
transmit an indication that the second transmission configuration indication state is linked to the first transmission configuration indication state.

24. The apparatus of claim 22, wherein the second transmission configuration indication state is linked to the first transmission configuration indication state according to a predefined rule.

25. The apparatus of claim 22, wherein the instructions are further executable by the processor to cause the apparatus to:
transmit, in the downlink control information, a first indicator to apply the first transmission configuration indication state for communicating with the second transmission and reception point.

26. The apparatus of claim 22, wherein the instructions are further executable by the processor to cause the apparatus to:
transmit, in the downlink control information, a third indicator to apply the first transmission configuration indication state for communicating with the second transmission and reception point and the second transmission configuration indication state for communicating with the first transmission and reception point.

27. The apparatus of claim 15, wherein a common application time or separate application times are configured for communicating with the second transmission and reception point in accordance with the first transmission configuration indication state and communicating with the first transmission and reception point in accordance with a second transmission configuration indication state.

28. The apparatus of claim 15, wherein the downlink control information comprises the indication of the first transmission configuration indication state without scheduling communications.

29. A method for wireless communication, comprising:
receiving an indication of a first set of transmission configuration indication states activated for a first transmission and reception point and a second set of transmission configuration indication states activated for a second transmission and reception point;
receiving, in downlink control information from the first transmission and reception point, an indication of a first transmission configuration indication state for communicating with the second transmission and reception point, the first transmission configuration indication state being from the second set of transmission configuration states; and
communicating with the second transmission and reception point in accordance with the first transmission configuration indication state.

30. A method for wireless communication, comprising:
transmitting an indication of a first set of transmission configuration indication states activated for a first transmission and reception point and a second set of transmission configuration indication states activated for a second transmission and reception point; and
transmitting, in downlink control information from the first transmission and reception point, an indication of a first transmission configuration indication state for communicating with the second transmission and reception point, the first transmission configuration indication state being from the second set of transmission configuration states.
